(19) United States
(12) Patent Application Publication
(10) Pub. No.: US 2007/0106429 A1
(43) Pub. Date: May 10, 2007

(54) Foreign object insertion detection system for vehicle seat

(75) Inventors: Masakazu Endo, Tsurugashima-shi (JP); Tetsuya Kayumi, Wako-shi (JP); Hirohide Suda, Wako-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignees: TOYO DENSO KABUSHIKI KAISHA, Tokyo (JP); HONDA MOTOR CO., LTD., Tokyo (JP)

(21) Appl. No.: 11/593,003

(22) Filed: Nov. 6, 2006

(30) Foreign Application Priority Data
Nov. 10, 2005 (JP) 2005-325863

(51) Int. Cl. G06F 17/00

(52) U.S. Cl. 701/1; 701/49

(57) ABSTRACT

An object of the present invention is to provide a control device for a vehicle seat that has a function enabling the accurate detection and immediate countermeasures even when a foreign object is sandwiched between the soft portions of the seats. According to a method of the present invention for detecting the insertion of a foreign object in a vehicle seat having a power slide mechanism, the foreign object insertion detection is performed by measuring a fluctuation AF of a seat drive force for each predetermined movement distance Δx and comparing the fluctuation quantity with a threshold Z. The threshold Z in this case is a fluctuation region value determined by subtracting, from a set threshold width h, a value [ΣKi(ΔF/Δx)i] obtained by successively adding up the products of the fluctuation quantity of the seat drive force for each predetermined movement distance and a coefficient Ki.

### BACKGROUND OF THE INVENTION

1. Field of the Invention

The present invention relates to a control device for a power seat for a vehicle that slidably moves, and more particularly to a control device for a vehicle seat with increased detection accuracy in the case where a foreign object is inserted between seats when the seat is moved.

2. Description of the Related Art

Automobile seats are equipped with a mechanism enabling the front-back and left-right movement according to the size of an occupant or cargo. When a seat is moved by using this mechanism, a foreign object sometimes gets between the seats. In particular, when a motor-powered seat is used, if the presence of the foreign object is undetected, the object is crushed. To solve this problem, the system has been provided with an overload detection function and control was employed to stop the electric motor when an overload was detected (Japanese Patent publication No. 61-67663 A1, “Posture Setting Device Installed on Vehicle”, the application was published on Apr. 7, 1986). Japanese Patent Publication No. 61-67663 A1 discloses a detection method by which “actual posture information outputted by a posture detection means such as a potentiometer is repeatedly sampled at fixed intervals, a posture variation rate is detected from the difference between a plurality of sampled posture data, an averaged posture variation rate information obtained by averaging a plurality of posture variation rates detected at mutually different timings is compared with a predetermined threshold value, and the presence or absence of overload is judged according to the comparison results”. Furthermore, Japanese Patent Publication No. 2004-210159 A1 (“Method for Actuation Control of Power Seat for Automobile”, the application is published on Jul. 29, 2004) discloses that the object of the claimed method is to prevent reliably the obstacles for the motor drive such as the insertion of a foreign object following the seat movement, to ensure a working space for an occupant and cargo space inside the vehicle, and to adjust reliably the linked movement of all the seats including the rear seats and also discloses that in order to attain this object, a load detection sensor is provided for detecting the load of a reversible motor, when an abnormal load is detected as seats are moved closed to each other, a complete stop control is performed by which the seat movement is temporarily stopped and the movement is reversed to a position where no abnormal load is detected, and when an abnormal load is detected as a seat cushion springs up, a complete stop control is performed by which the spring-up movement of the seat cushion is temporarily stopped and the seat cushion is returned to the original seating position.

As a specific example, let us consider a vehicle equipped with foldable seats such as shown in FIG. 6 and an event in which a foreign object is sandwiched between the seats in this vehicle. The seats of the second row in this vehicle are independently installed on the left and right sides and comprise a slide mechanism that can move the seats back and forth along the slide rails. The movement to the left and right can be also enabled by providing the seats with a left-right slide sections such as shown in the exploded perspective view in FIG. 7. Furthermore, the seat has a mechanism by which a seat cushion is caused to spring up and fold on the seat back side as shown in FIG. 8. When the vehicle is used, the seats thereof are moved or folded and unfolded from time to time as necessary, and in those operations, foreign objects can be hit or sandwiched in a variety of forms. For example, a second-row seat is sometimes power slid toward a first-row seat between the first-row seat and second-row seat shown in FIG. 6. However, in the case where a foreign object is inserted between the automobile seats, the characteristics of a load applied to the foreign object are different when the foreign object is sandwiched between hard portions of the seat (for example, A in FIG. 6) and soft portions of the seat (for example, B in FIG. 6). When a hard foreign object is sandwiched between hard portions, a load in a drive source such as a motor rises abruptly as a counteraction and, therefore, an overload of the drive source can be detected. However, when a foreign object is inserted between the soft portions, the reaction force acting upon the seat is small. As a result, the judgment as to whether or not a foreign object has been sandwiched is difficult to make accurately and rapidly with the above-described conventional device.

### SUMMARY OF THE INVENTION

It is an object of present invention to provide a control device for a vehicle seat that has a function that enables accurate detection and immediate countermeasures even when a foreign object is sandwiched between the soft portions of seats.

The foreign object insertion detection method for a vehicle seat in accordance with the present invention is a method for performing the foreign object insertion detection in a vehicle seat having a power slide mechanism by measuring a fluctuation ΔF of a seat drive force for each predetermined movement distance Δx and comparing the fluctuation quantity with a threshold Z, wherein the threshold Z in this case is a fluctuation region value determined by subtracting, from a set threshold width h, a value [ΣKi(ΔF/Δx)i] obtained by successively adding up the products of the fluctuation quantity of the seat drive force for each predetermined movement distance and a coefficient Ki.

The coefficient Ki is a value determined for each predetermined movement distance Δx from a foreign object sandwiching start position, this value corresponding to a resilience characteristic of the seat. For example, it can be suggested to use as the coefficient Ki a value which is read from a table of constants obtained by performing a foreign object sandwiching test by using the seat and performing optimization.

The foreign object insertion detection device for a vehicle seat in accordance with the present invention comprises a vehicle seat having a power slide mechanism, a direct current motor of a drive source of the slide mechanism, means for measuring a slide position x of the vehicle seat by the rotation of the motor, means for measuring a drive source voltage V of the motor or means for determining a drive force F of the motor, and a table of constants for allocating coefficients Ki that are set in advance according to a fluctuation quantity (ΔF/Δx)i of the drive force for each predetermined movement distance, wherein an insertion is detected when ΣKi(ΔF/Δx)i exceeds a threshold width h that is set in advance. The means for allocating the drive force F of the motor may directly measure the drive force F or may measure a drive source voltage V of the motor and calculate the drive force F indirectly from a torque T by formula (1) presented hereinbelow.

The foreign object insertion detection method for a vehicle seat in accordance with the present invention is a method for performing the foreign object insertion detection in a vehicle seat having a power slide mechanism by measuring a fluctuation ΔF of a seat drive force for each predetermined movement distance Δx and comparing the fluctuation quantity with a threshold Z, wherein the threshold Z in this case is a fluctuation region value determined by subtracting, from a set threshold width h, a value [ΣKi(ΔF/Δx)i] obtained by successively adding up the products of the fluctuation quantity of the seat drive force for each predetermined movement distance and a coefficient Ki. Therefore, even when a foreign matter is sandwiched by soft portions of the seats, the insertion of the foreign matter can be detected with good accuracy by reducing a threshold value by adding up the increments of the drive force of the sheet for each predetermined distance of slow movement. Moreover, because a fluctuation component caused by noise represents random fluctuations, it does not yield a large value even upon integration and causes no malfunction.

The coefficient Ki is, for example, a value determined for each predetermined movement distance Δx from a foreign object sandwiching start position that employs a value which is read from a table of constants obtained by performing a foreign object sandwiching test by using the seat and performing optimization. Therefore, coefficient Ki can reflect the drive force fluctuations after the start of insertion that corresponds to a resilience characteristic of the seat and a highly accurate foreign matter insertion detection can be realized.

The foreign object insertion detection device for a vehicle seat in accordance with the present invention comprises a vehicle seat having a power slide mechanism, a direct current motor of a drive source of the slide mechanism, means for measuring a slide position x of the vehicle seat by the rotation of the motor, means for determining a drive force F of the motor, and a table of constants for allocating coefficients Ki that are set in advance according to a fluctuation quantity (ΔF/Δx)i of the drive force for each predetermined movement distance, wherein an insertion is detected when ΣKi(ΔF/Δx)i exceeds a threshold width h that is set in advance. Therefore, a control device can be provided that requires no special hard components such as sensors in addition to the conventional device and realizes the foreign object insertion detection with good accuracy by software measures such signal processing and providing a table of constants obtained by tests or the like.

### BRIEF DESCRIPTION OF THE DRAWINGS

FIG. 1 is a graph illustrating the relationship characteristic of the torque, electric current, and rotation rate of the motor;

FIG. 2 illustrates the operation of the insertion detection system in accordance with the present invention;

FIG. 3 illustrates the relationship between the motor displacement, motor load, and coil current;

FIG. 4 is a block diagram illustrating the first embodiment of the present invention;

FIG. 5 illustrates the circuit configuration of the first embodiment of the present invention;

FIG. 6 is a perspective view of all the seats in an automobile employing the present invention;

FIG. 7 illustrates a drive mechanical of the seat; and

FIG. 8 is an explanatory drawing of a seat having a folding function.

### DESCRIPTION OF THE PREFERRED EMBODIMENT

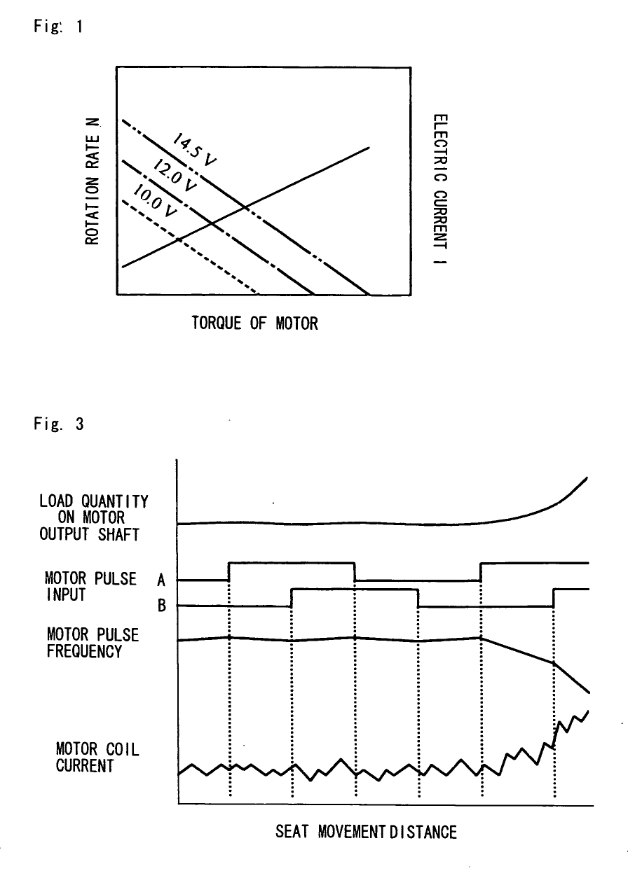

An event in which a foreign object is sandwiched between the seats will be briefly analytically explained prior to suggesting the implementation mode of the present invention. If an insertion phenomenon occurs in a seat that is moved by a drive motor, a load applied to the drive motor increases. In accordance with the present invention, this load characteristic of the motor is used and a load increase caused by the foreign object insertion is detected from the principle formula of a direct current motor. A torque T of a motor is proportional to an energizing current I of the motor. If the torque coefficient is represented by Kt, the following equation is valid: T=Kt×I. When a load is applied to the motor and a brake is also applied, the rotation rate N of the motor drops. If the rotation rate drops, the induced electromotive force V′ of the motor decreases. The induced electromotive force is V′=Ke×n, where Ke stands for a power generation coefficient of the motor, and if the induced electromotive force V′ decreases with respect to a voltage V between the motor terminals, then the difference V−V′ in voltage applied to the coil increases and the electric current I flowing in the coil increases due to the following relationship: V−V′=I×R. Here, R is an electric resistance of the coil. As a result, due to the above-described relationship T=Kt×I, the operation is performed in which the output torque T of the motor increases. The torque T of the motor, rotation rate N of the motor, and the value of electric current I flowing in the motor generally satisfy the first-order relationship such as shown in FIG. 1, that is, the relationship in which the electric current I flowing in the motor is proportional to the torque and the relationship in which the rotation rate N of the motor is inversely proportional to torque T, and a shift is known to be caused by the voltage V−V′ applied to the coil. A solid line in FIG. 1 is a current value/torque, a wavy line is a rotation rate/torque when operating at 10.0 V, a dot-dash line is a rotation rate/torque when operating at 12.0 V, and two-dot-dash line is a rotation rate/torque when operating at 14.5 V. A method of measuring the rotation rate N of the motor and a method for measuring the electric current I can be employed for detecting the load applied to the motor from the above-described relationship characteristic.

With the method of measuring the rotation rate of a direct current motor, a pulse period data corresponding to the rotation rate N of the motor, a voltage V between the motor terminals, and a ratio [DUTY] in an ON state of PWM (pulse width modulation) are used as input parameters and a torque T is represented by the following formula.
T=K×V×DUTY−K×Ke×N (1)
Here, K is a coefficient corresponding to (motor torque coefficient Kt÷motor resistance R); Ke is a coefficient correspond to a motor power generation coefficient.

With the method for measuring the torque, the energizing current (time-average value) I of the motor and a ratio [DUTY] in an ON state of PWM are used as input parameters and the torque T is represented by the following formula.
T=Kt×I×DUTY×Kft (2)
Here, Kft is a value corresponding to a friction torque.

When a foreign object comes into contact with a moving seat, the drive load of the motor is increased, but the load variation mode is not uniform and a characteristic corresponding to the contact mode is demonstrated. When a foreign object is pressed in as the seat starts to move, the torque rapidly increases from the very beginning. If the foreign object is sandwiched between the seats at the intermediate stage of seat movement, the torque force rapidly increases from the point in time in which the foreign object was sandwiched, rather than from the very beginning. Furthermore, when the foreign object collides with the seat and skips over it, the response is such that the torque force increases in a pulse-like fashion from the point in time of collision, rather than changing from the very beginning, and then returns to the original torque. Such response is manifested as a significant change when the foreign object comes into contact with the hard portions of the seat, thereby facilitating the detection, but when the foreign matter comes into contact with soft portions, the change is small and the detection is, therefore, difficult. If the drive force of the seat is taken as F and the movement distance of the seat is taken as x, the algorithm of the conventional foreign object insertion detection will be such that when the insertion occurs in the hard portions of the seat, the variation quantity (ΔF) of the seat drive force for each predetermined distance (Δx) will be large. For this reason a method has been employed according to which, for example, one threshold value ZO was prepared and a timing at which (ΔF/Δx)i>ZO was measured. In the ZO value used herein, the seat hardness and the like are included in the value found in advance by verifying, e.g., by a test, a value observed when the insertion has actually occurred. However, with this conventional method, the fluctuation is small when the foreign object is inserted into the soft portions or when a soft foreign object such as a child is inserted. As a result, the detection is difficult. If a low threshold value ZO is set to increase the detection sensitivity, the malfunction caused by noise occurs frequently.

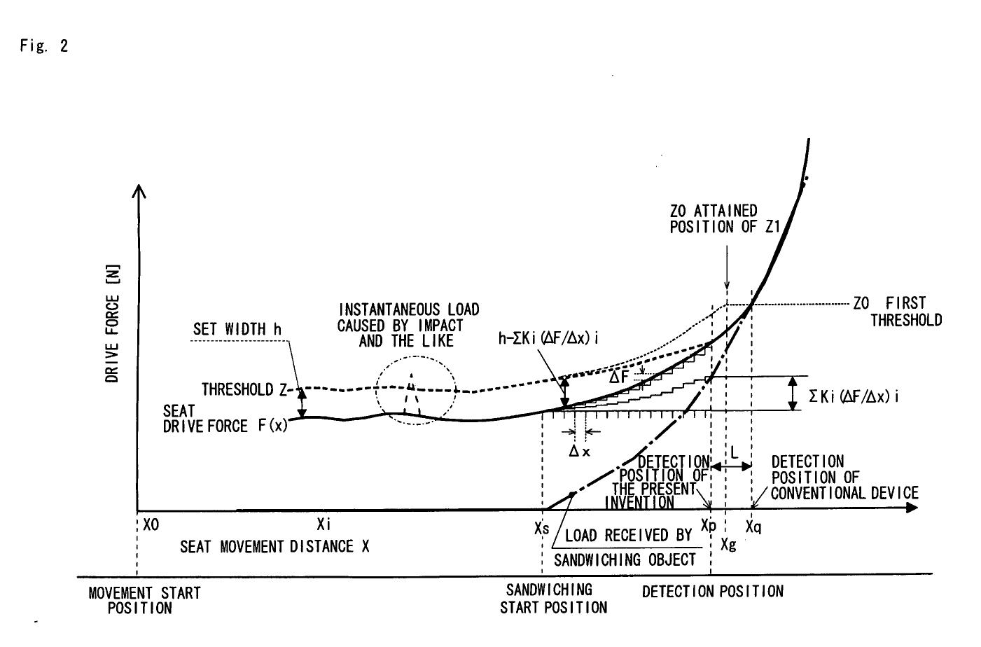

Furthermore, when a foreign object collides with a moving seat and is skipped over it, without being inserted therein, a pulse-shaped force is instantaneously applied, without continuous increase in load. To deal with such an event, a method has also been used by which a certain threshold width h (constant) was prepared for a drive force F of a seat, this threshold value was added to a drive force F(x×1) of the seat of the previous measurement cycle to obtain Z1=F(x×1)+h, and this fluctuation threshold value Z1 was compared with the present drive force F(x) of the seat so that the insertion is detected when the variation quantity AF of the force exceeds the threshold width h. In this case, even if the torque does not exceed a fixed threshold value ZO, because the peak value thereof as a fluctuation of pulsed-like force that is applied instantaneously, exceeds the aforementioned fluctuation threshold Z1 (see an effect shown in a round frame in FIG. 2, which is an explanatory drawing illustrating the operation of the present invention), the aforementioned case can be handled by such method. However, when a foreign object is inserted into a soft portion, the load increases gradually and no pulse-shaped force variations are observed. The resultant problem is that even if the insertion occurs, it cannot be detected by this detection method. It is an object of the present invention to provide a detection method capable of dealing with such an event.

In accordance with the present invention, a system for determining a fluctuation threshold value Z1=F(x−1)+h is employed, this value being obtained by adding a certain threshold width h to a drive force F of the seat and also a determination system is included that is effective in the process in which the load increases gradually so as to deal with the case where a foreign object is inserted in a soft portion.

In accordance with the present invention, a coefficient Ki corresponding to the variation quantity (ΔF/Δx)i of the seat drive force is set in advance for each predetermined movement distance and the total sum ΣKi(ΔF/Δx)i of the products of the two, that is, Ki(ΔF/Δx)i, is successively calculated in the response to the movement of the seat. This coefficient Ki is a value found correspondingly to the soft portion of the seat. When a foreign object is sandwiched between the soft portions, the drive force gradually increases. As a result, the variation quantity ΔF of the drive force of each predetermined distance Δx does not exceed h and, therefore, cannot be detected by comparing the fluctuation region value Z1 and the present drive force F(x) of the sheet, but a small variation of drive force is also reflected in the ΔF. Accordingly, if a variation quantity (ΔF/Δx) of the seat drive force for each predetermined distance is multiplied by the coefficient Ki, the products are added up successively, the sum is deducted from the preceding fluctuation region value Z1, the result is calculated as a new threshold value Z, and this Z value is compared to the present drive force F(x) of the seat, then a drive force that gradually increases with time, as in the case where a foreign object is sandwiched between soft portions, can be also detected. Thus, a new threshold value Z employed by the present invention is found by subtracting ΣKi(ΔF/Δx)i from the conventional threshold value F(x)+h, whereby the threshold value is eventually gradually reduced and a judgment is made by comparing and determining whether or not the present drive force F of the seat exceeds the reduced threshold value. The determination method can be represented as follows:

(1) A threshold value Z is found as
Z=F(x−1)+h−ΣKi(ΔF/Δx)i (3).

(2) The present drive force F(x) is compared with the threshold value Z and an insertion is judged to have occurred when Z<F(x).

The value of the coefficient [Ki] used herein is prepared as a table of constants obtained by conducting preliminary drive tests of various insertion cases that can be encountered with the object seat, measuring in advance the variation (ΔF/Δx)i of the seat drive force, the elastic modulus of the seat sections that came into contact with a foreign object, and the like, and performing optimization.

The operation of the present invention will be described below in greater detail with reference to FIG. 2. In the figure, a movement distance of a seat is plotted against the abscissa and an assumption is made that a foreign object starts to be sandwiched between the soft portions of the seats when the seat reaches a position Xs; Xg indicates a position in which the conventional fluctuation threshold value Z1 is equal to a fixed threshold ZO and position such that the subsequent threshold values become the fixed threshold value ZO. A force [Newton] is plotted against the ordinate, a thick solid line in the figure represents the variation of the drive force of the seat, a thick wavy line represents the threshold values in accordance with the present invention, and a thick dot-dash line represents a load applied to the sandwiched foreign object. Furthermore, a thin wavy line in the figure shows the conventional fluctuation region value Z1 and fixed threshold value ZO. A sheet drive force before the position Xs in which the insertion is started, demonstrates random fluctuations within a supposed range that are caused by the acceleration of the vehicle or inclination of vehicle body. Therefore, AF assumes a value close to 0 and (ΔF/Δx)i is equal to 0. Even if a certain small value is detected, ΣKi(ΔF/Δx)i can be taken as 0 since random fluctuations are realized. Therefore, in this region, the threshold value Z in accordance with the present invention is substantially not different form the conventional Z1. Furthermore, when a foreign object collides with a hard portion of the seat in which region, the seat drive force F(x) changes in a pulse-like fashion, as shown within a round frame in the figure. The peak value of the pulse at this time exceeds the threshold value width h and, therefore, the collision of the foreign matter can be detected.

The insertion of the foreign matter into a soft portion is assumed to be started when the moving seat reaches a position Xs. Though the foreign object is sandwiched, because the portions that are in contact therewith are soft, no abrupt increase in the seat drive force F(x) is observed and AF does not exceed the threshold width h. However, an increment is detected in this value of ΔF. The increment is also detected in ΔF at the time in which a unit displacement quantity Δx was realized because the sandwiched state is maintained. The present invention employs a method of successively adding up the variation quantities (ΔF/Δx)i of the seat drive force for each predetermined distance. Therefore, by conducting the computation of ΣKi(ΔF/Δx)i, this ΣKi(ΔF/Δx)i fraction is subtracted from the threshold value Z. The coefficient Ki is set correspondingly to the soft portions, as was described hereinabove. Because the insertion is thus judged by reducing the threshold value, the foreign object insertion is detected at a point in time Xp in which ΣKi(ΔF/Δx)i reaches the threshold width h that has been set. Thus, the insertion of the foreign matter can be detected at a distance L before the point Xq in which the seat driver force F(x) reaches the predetermined threshold value Z0. Thus, in accordance with the present invention, a delay-free detection can be conducted not only with respect to insertion into hard portions, but also when the foreign matter is inserted into a soft portion and the detection accuracy can be increased. Moreover, the threshold value Z is decreased by deducting ΣKi(ΔF/Δx)i from the predetermined threshold value width h, but this is reflected on the case where the variation quantity ΔFi of the seat drive force increases continuously. Therefore, a malfunction caused by noise does not occur frequently as in the case where the threshold value is simply decreased. When a foreign object is sandwiched between hard parts, a rapid monotonous, rather than pulse-like, increase takes place. Therefore, when the ΔF value exceeds the threshold width h, the insertion of the foreign matter can be detected instantaneously. If this is not the case, because the ΣKi(ΔF/Δx)i fraction for several cycles exceeds the threshold value width h, the insertion of the foreign matter can be detected before the seat drive force F(x) reaches the fixed threshold value ZO.

In the case of load fluctuations that are not associated with insertion of a foreign object, for example, when a foreign object is present on a rail, the load temporarily increases, but immediately thereafter decreases. In this case, measures are taken to add the corrosion correction values corresponding to a temporary increase and decrease of load fluctuations to the preceding threshold value Z. Thus, a malfunction is prevented by adding a correction value [Ki(ΔF/Δx)i] for a temporary increased load to the threshold value Z and deducting a correction value [Ki+1(ΔF/Δx)i+1] corresponding to subsequent decrease in the load.

An embodiment using a rotation rate of a direct current motor as means for measuring the seat drive force will be described below. A time that elapsed from a previous pulse edge is counted with clock pulses for each pulse edge input of motor pulses A, B of two sequences shifted in phase by π/2. A motor pulse corresponds to the timing of switching to a terminal where a DC voltage is applied and corresponds to the rotation of motor. If an insertion occurs in the seat movement process, a load is applied to the output shaft of the motor, and the rotation rate (speed) of the motor decreases. Therefore, the time spacing between the pulse edges in this case increases and the number of clock pulses that are counted is increased. If the load of the output shaft of the motor tends to increase, as shown in FIG. 3, the frequency of motor pulses decreases inversely proportionally to the load. For this reason, in the present embodiment, this pulse frequency is used as being equivalent to the motor rotation rate N represented by Formula (1) above, and the spacing between pulse edges is taken as a unit displacement quantity Δx of the sheet. The computation of Formula (1) is performed of each spacing between the pulse edges and ΔF=Ti−Ti−1, which is the difference between the present value and the previous value, is found.

Furthermore, in the embodiment in which the drive force of the seat is measured from the electric current flowing in a motor coil, the A/D conversion of the current detection circuit is actuated after each main period of the controller for motor control, and the value of electric current in the motor coil at this time is measured as a difference in potential between the shunt resistors. The value of electric current flowing in the motor coil becomes almost corresponding to the load quantity on the motor output shaft as shown in FIG. 3. Because the timing of this measurement does not correspond to the unit displacement quantity Δx, the pulse edge spacing is taken as a unit displacement quantity of the seat and the electric current I obtained by arithmetically averaging a plurality of data measured within this period is employed in Formula (2).

### EXAMPLE 1

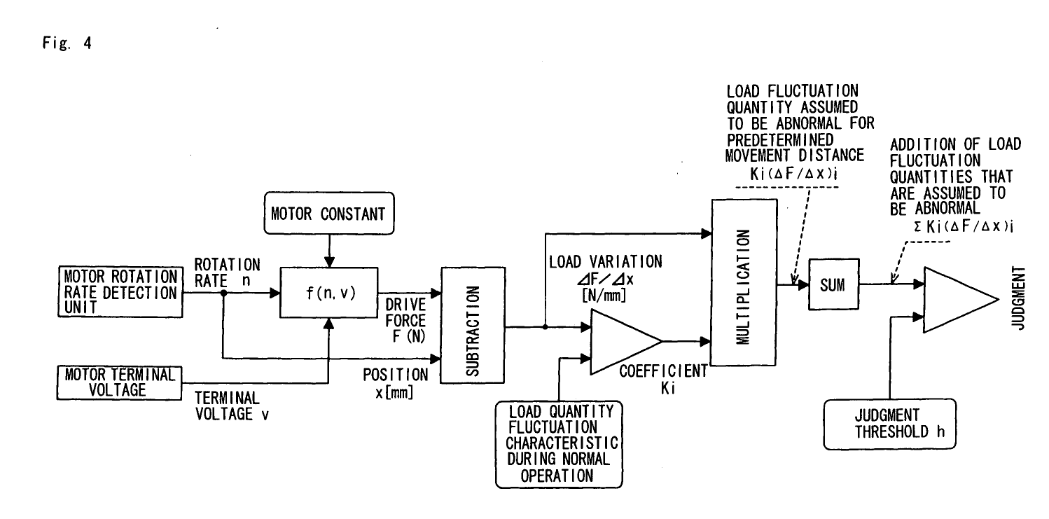

A block diagram shown in FIG. 4 illustrates Example 1 based on a motor pulse detection system. The measure value of the voltage V between the motor terminals and motor pulse period (rotation rate N) data obtained with the motor rotation rate detection unit are used as input parameters. Furthermore, a motor torque coefficient, motor resistance, motor power generation factor, and [DUTY] value are prepared as property information of the motor used and a drive force F of the motor is computed. The motor rotation rate information obtained with the motor rotation rate detection unit is integrated and movement distance information for the seat is obtained. The preceding drive force F is subtracted and a drive force fluctuation per unit displacement, ΔF/Δx, is calculated. This drive force fluctuation [ΔF/Δx]i outputted successively corresponding to the displacement of the seat is compared with the values relating to the normal operation that were accumulated by the earlier conducted tests, and if the difference between the computed value and comparison value is equal to or larger than the allowed value, for example, because the insertion phenomenon has occurred, an abnormal state is judged, the coefficients Ki of the table of constants that was obtained by the above-described optimization are employed, the multiplication computation of the drive force fluctuation [ΔF/Δx]i and the coefficient Ki is performed, and the values obtained are added up. When the comparison of the previous drive force fluctuation and the accumulated values relating to normal operation demonstrates an abnormality, but the operation is thereafter restored in a normal range, this abnormality is a random noise rather than the insertion phenomenon. Therefore, in this case, as described hereinabove, the difference between the decrease and increase in a temporary load fluctuation is employed as a correction value for the threshold Z, this correction value is added to the threshold Z preceding the fluctuation (return to the normal value), and malfunction is prevented. Furthermore, the sum ΣKi(ΔF/Δx)i is compared with the determined threshold h and the insertion judgment is made when the sum exceeds the threshold.

Comparing the threshold h and the sum ΣKi(ΔF/Δx)i is technically synonymous to comparing the above-described threshold Z=F(x−1)+h−ΣKi(ΔF/Δx)i with the present drive force F(x) and determining the occurrence of the insertion when Z<F(x), once the drive force F(x−1) of the previous measurement position has been removed.

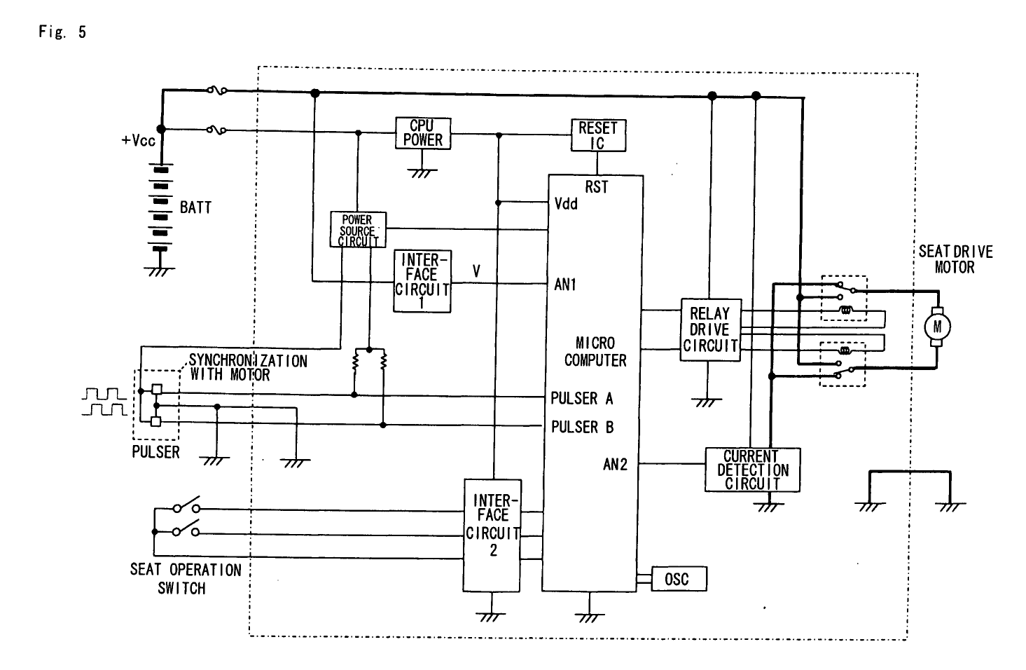

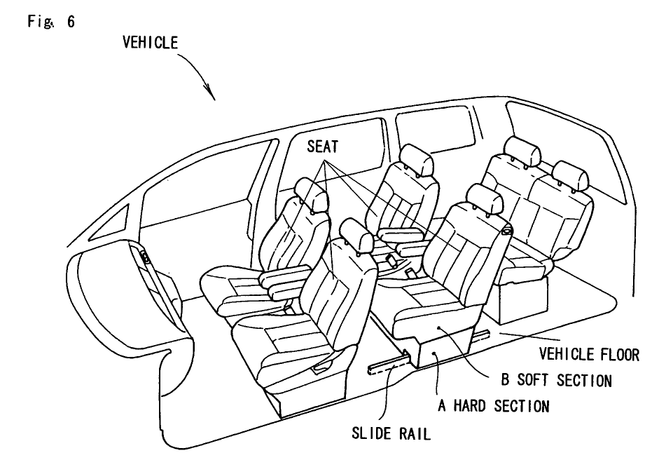

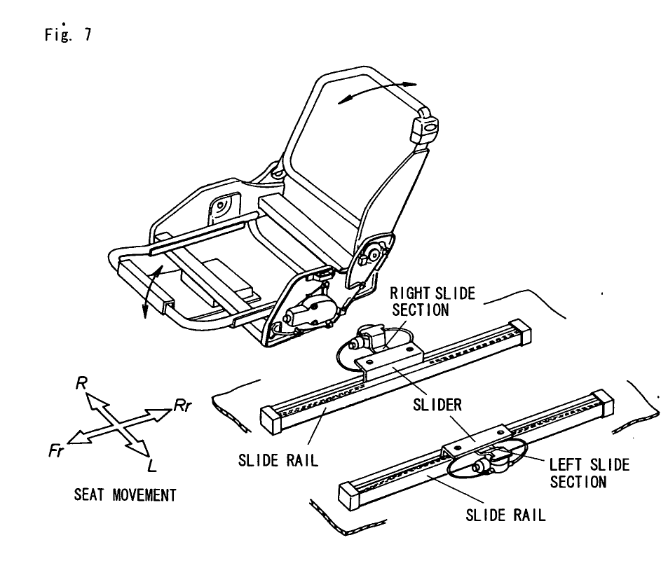

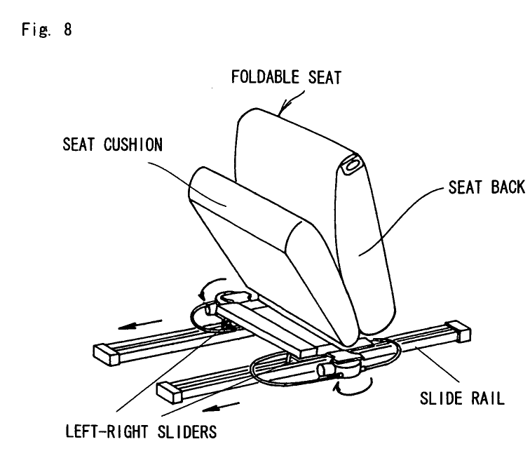

FIG. 5 illustrates the present embodiment by means of electric circuit diagram. In the figure, a pulser represented by wavy lines at the left end in the central section of the figure corresponds to a rotation rate detection unit of the motor. The two pulse sequences A and B are shifted in phase by π/2 with respect to each other and outputted correspondingly to the rotation phase of the rotation shaft. They serve for detecting the rotation rate of the rotor or the output shaft of the DC motor. The elapsed time for each edge timing of the two pulse sequences is counted by clock pulses in a microcomputer (abbreviated as MC hereinbelow). This clock is provided by an oscillator OSC. The current detection circuit in the lower right section of the figure that serves to measure the current flowing in the seat drive motor position at the right end of the figure is designed for measuring the current of the motor shown in FIG. 4, and the results are sent from the analog input terminal AN2 to the MC for measurement. Furthermore, the terminal voltage of the motor is sent from the analog input terminal AN1 via the interface circuit 1 shown in FIG. 5 to MC for measurement. The motor torque coefficient, motor resistance value, motor power generation coefficient, [DUTY} value, and table of constants of coefficients Ki obtained by optimization are stored in the memory in the MC, and all the operations of computing the drive force F, finding the load variation ratio (ΔF/Δx)i for each unit displacement, multiplying the load variation ratio (ΔF/Δx)i by the coefficient Ki, computing the sum ΣKi(ΔF/Δx)i, comparing the drive force fluctuation [ΔF/Δx]i and the value corresponding to the normal operation, and comparing the threshold h with the sum ΔKi(ΔF/Δx)i are performed in the MC.

The power source for the MC is shown by CPU Power in the figure, and the battery output is regulated thereby.

What is claimed is:

1. A foreign object insertion detection method for a vehicle seat having a power slide mechanism by which the foreign object insertion detection is performed by measuring a fluctuation ΔF of a seat drive force for each predetermined movement distance Δx and comparing the fluctuation quantity with a threshold Z, wherein said threshold Z in this case is a fluctuation region value determined by subtracting, from a set threshold width h, a value [ΣKi(ΔF/Δx)i] obtained by successively adding up the products of the fluctuation quantity of the seat drive force for each predetermined movement distance and a coefficient Ki.

2. The foreign object insertion detection method for a vehicle seat according to claim 1, wherein the coefficient Ki is a value determined for each predetermined movement distance Δx from a foreign object sandwiching start position, this value corresponding to a resilience characteristic of the seat.

3. The foreign object insertion detection method for a vehicle seat according to claim 2, wherein the coefficient Ki is a value which is read from a table of constants obtained by performing a foreign object sandwiching test by using the seat and performing optimization.

4. A foreign object insertion detection device for a vehicle seat, comprising:
a vehicle seat having a power slide mechanism;
a direct current motor of a drive source of the slide mechanism;
means for measuring a slide position x of the vehicle seat by a rotation of said motor;
means for determining a drive force F of said motor; and
a table of constants for allocating coefficients Ki that are set in advance according to a fluctuation quantity (ΔF/Δx)i of the drive force for each predetermined movement distance, wherein an insertion is detected when ΣKi(ΔF/Δx)i exceeds a threshold width h that is set in advance.
